(19) United States
(12) Patent Application Publication
(10) Pub. No.: US 2011/0054924 A1
(43) Pub. Date: Mar. 3, 2011

(54) PATIENT COMMUNICATIONS DEVICE

(76) Inventors: Jaime Tadeo Mitchell, Bethlehem, PA (US); Floyd B. Willis, Jacksonville, FL (US)

(21) Appl. No.: 12/509,135

(22) Filed: Jul. 24, 2009

Related U.S. Application Data
(60) Provisional application No. 61/083,820, filed on Jul. 25, 2008.

(51) Int. Cl. G06Q 50/00; G01C 21/00; G06F 15/16; G06F 3/048

(52) U.S. Cl. 705/2; 701/201; 715/753

(57) ABSTRACT

A handheld patient communication device (10) comprises a data port (12), a memory (14), a processor (16), and a patient interface device (18). The data port (12) is a “wireless” data port, meaning only that it is not hard-wired to the service provider operating system (30). This allows the patient to input, review and update personal information and medical information, view documents and videos selected by the doctor for that patient, take tests for evaluation of the patient's knowledge of, cause of, and treatment for, the underlying medical condition so that the doctor can more effectively determine the appropriate treatment for that patient.

### PRIORITY CLAIM

This patent application claims the priority of U.S. Provisional Patent Application Ser. No. 61/083,820, entitled “Mobile Patient Communicator”, and filed Jul. 25, 2008 by Floyd Banard Willis and Jaime Tadeo Mitchell, the complete contents of which are hereby incorporated herein by reference.

### BACKGROUND OF THE INVENTION

1. Field of the Invention

(1) The present invention relates to patient communications, education, and testing.

(2) Description of the Related Art

Currently, when a patient enters a doctor's office or a hospital, the receptionist hands the patient a clipboard, numerous forms, and a pen, and tells the patient to complete all of the forms and return them to the receptionist. The patient's reaction, although usually not expressed, can vary from being frustrated by the number of forms or even infuriated by having to complete the same forms he or she filled out at the last visit, or even for a different department. Some offices and hospitals direct the patient to a service window, where an employee, such as a nurse, an administrator, or other professional, reads information about the patient on a screen and asks the patient to verify that the information is still correct. This avoids needlessly having to fill in forms again, but incurs extra expense in that an employee is needed to converse with the patient to verify and/or update the information, and is still a slow process because the employee has to read the information to the patient, wait for the patient to affirm the information or indicate that it has changed, and then input the changes stated by the patient. This process can also introduce errors.

Once the patient's information is updated, the patient then reads a magazine he or she brought along, or selects a magazine from the various periodicals (human interest, sports, cars, fashion, etc.) available in the waiting room, or perhaps selects one of the various pamphlets available about the doctor's services or general information about diseases or disorders.

### BRIEF SUMMARY OF THE INVENTION

A portable patient communication device has a wireless data port to receive data related to at least one of information concerning a person, information for a person, or operating instructions, an interface device to at least one of display information to a person or to receive information from a person, a memory to contain operating instructions, and a processor, functionally connected to the wireless data port, to the interface device, and to the memory, to retrieve and execute an operating instruction, and at least cause a portion of the information received by the data port to be displayed on the interface device or cause at least a portion of the information received by the interface device from the person to be stored.

The patient can input, review and update personal information and medical information, view documents and videos selected by the doctor for that patient, take tests for evaluation of the patient's knowledge of, cause of, and treatment for, the underlying medical condition. This allows the doctor to more effectively determine the appropriate treatment for that patient.

### BRIEF DESCRIPTION OF THE SEVERAL VIEWS OF THE DRAWING

FIG. 1 is block diagram of an exemplary embodiment of the present invention in an exemplary environment.

FIG. 2 is an exemplary embodiment of a portable patient communication device.

FIG. 3 is an illustration of an exemplary screen.

FIG. 4 is an illustration of part of an exemplary patient medical history intake form or questionnaire display.

FIG. 5 is an illustration of an exemplary consent display.

FIG. 6 is an illustration of an exemplary display guiding the patient to a desired location.

FIG. 7 is an illustration of an exemplary patient education video display.

FIG. 8 is an illustration of an exemplary medication reconciliation status display.

FIG. 9 is an exemplary embodiment of a professional communication device.

### DETAILED DESCRIPTION OF THE INVENTION

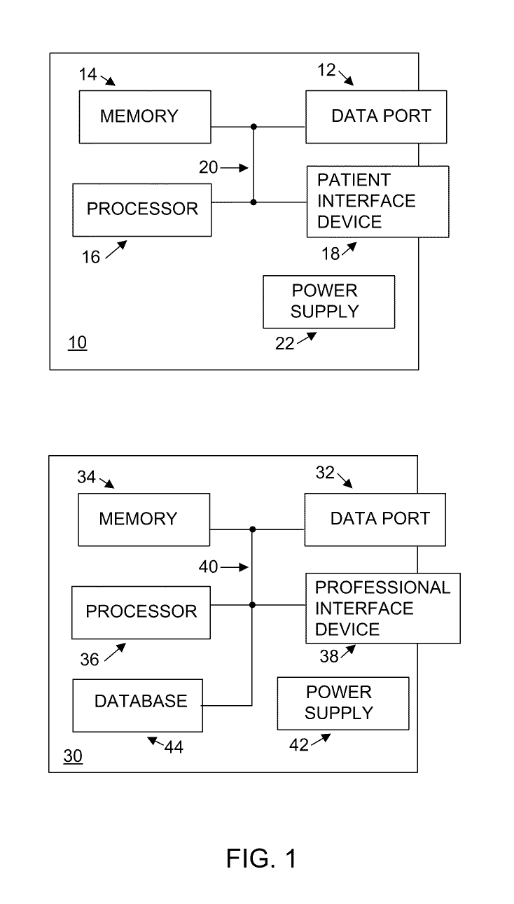

FIG. 1 is block of an exemplary embodiment of the present invention in an exemplary environment. A patient communication device 10 comprises a data port 12, a memory 14, a processor 16, and a patient interface device 18, interconnected by a data/control bus 20, and a power supply 22. The patient communication device 10 is a handheld device, which may range in size from a cellular telephone to a laptop computer; the size being primarily determined by the patients who will be using the device. A smaller device might be satisfactory for a younger, more dexterous person, but a larger device might be necessary for older persons, who often have trouble seeing small print or manipulating tiny keys. Also, the device should be convenient for the patient to hold while reading or inputting information. In one embodiment, the device is implemented using a Medislate™ device by Tabletkiosk.

The data port 12 is a “wireless” data port, meaning only that it is not hard-wired by a cable to the service provider operating system 30. Thus, data port 12 may provide a wireless link, such as by a radio frequency transceiver, an infrared transceiver, an ultrasonic transceiver, or a universal serial bus (USB) or other port for accepting a memory device, such as a memory card or a memory “stick”. A device may have more than one data port. For example, a device may have one data port to provide a wireless link and another data port to accommodate a memory card. For convenience of illustration, neither a memory card nor a wireless link are separately shown, as such techniques are well known. The use of such techniques in the manner described herein is, however, novel.

The patient interface device 18 may be a single device, such as a touch-sensitive screen, or may be a plurality of devices, such as a display screen (which may or may not be a touch-sensitive screen) and one or more physical buttons or switches. The patient interface device 18 presents information to the patient and accepts information from the patient.

A medical (or other) service provider operating system 30 comprises a data port 32, and preferably a plurality of such data ports, a professional interface device 38, and preferably a plurality of such professional interface devices, a memory 34, a processor 36, and a database 44, interconnected by a data/control bus 40, and a power supply 42.

The data port 32 is, like the data port 12, a wireless data port. In one embodiment, data is transferred between the patient communication device 10 and the system 30 via transceivers, such as mentioned above. In another embodiment, data is transferred between the patient communication device 10 and the system 30 via a memory device, such as a memory card or a memory “stick”. In still another embodiment, both transceivers and memory devices may be used.

The professional interface device 38 may be, similar to the patient interface device 18, a single device, such as a touch-sensitive screen, or may be a plurality of devices, such as a display screen (which may or may not be a touch-sensitive screen) and one or more buttons or switches. The professional interface device 38 may also be a conventional computer terminal or data terminal. The professional interface device 38 allows a professional, such as a doctor, nurse, or administrative assistant, to access or update patient information, review and select information, including articles, videos, etc., to be presented to the patient via the patient communication device 10, review results of any tests administered to the patient via the patient communication device 10, provide specific instructions to the patient via the patient communication device 10, etc.

The database 44 may comprise one or more servers, which may reside locally and/or may actually be located at one or more remote locations. The database 44 contains patient information, information which can be selected for the patient to review, such as articles, videos, patient questionnaires, results of any tests administered to the patient, a record of specific instructions provided to the patient, questions or comments from the patient, etc.

Consider now an exemplary use. A patient arrives at a medical facility, such as a doctor's office, a medical center, a hospital, etc., and advises the receptionist that he (or she, or they) has arrived. The receptionist will then hand the patient, or direct the patient to, a patient communication device 10. The patient takes the device 10, sits down, and may press a “start” or “begin” or other icon or button, or the device 10 may start up upon insertion of the memory card into the data port 12, or the receptionist may key in a code or start up the device. The device 10 will access the data for that patient from the system 30 via the data port 12, and then present the appropriate information to the patient via the interface 18. The information may be on a memory card inserted into the data port 12, or may be obtained from the server 30 using the wireless capabilities of the data port 12, or both.

If the patient is a new patient, then a new patient intake questionnaire form may be presented for the patient to complete. Preferably, but not necessarily, some information is already present on the form, such as the patient's name, address, telephone number, medical insurance information, etc. The patient then proceeds, using the interface 18, to provide the missing information, such as, for example, a statement and symptoms of the medical condition causing the visit, a medical history of past operations, diseases, a listing of medications currently being taken, etc. The information is preferably, but not necessarily, entered via the touch-sensitive screen by pressing a “yes” or “no” icon, check box, or other appropriate selection. A keyboard display may also be provided so that the patient can type in information. If the patient is an established patient, then the patient's existing information may be displayed and the patient asked to verify or update the information.

Once this has been done the updated information is provided to the system 30. For example, the device 10 may transmit the patient's changes to the system 30 using the data port 12, or the patient may return the device 10 to the receptionist so that the receptionist can remove the memory card and insert it into a data port for the system 30. The device 10 may also present other information to the patient for the patient to review. For example, if the patient is a diabetic, the device 10 may present information regarding the causes and effects of diabetes, different types of treatments therefor, methods and actions to control one's blood sugar level, new treatments for diabetes, medications, herbs, and supplements which are helpful or are contraindicated, etc. The device 10 may also ask questions of the patient before, during, and/or after the presentation to determine the patient's level of awareness of his medical condition. This is useful because it allows the physician to better determine the appropriate treatment for the patient. For example, if a patient scores poorly on the test the physician may prescribe a course of action which requires minimal decisions by the patient—“do not ever eat any of these foods.” If, however, the patient scores highly, then the physician may allow the patient more latitude—“you can eat these foods, but only in moderation, and only occasionally.”

Once the above has been completed, then the patient may be able to use the device 10 to review other information, such as books, newspapers, magazines, etc., which are on the database, or the patient may choose to “surf” the Internet using the device 10, select and play a game on the device 10, etc.

When the patient is called, the device then provides the patient with a map and/or directions how to reach the location, such as a room or area, where the patient is to go next, and what the patient should do then.

Thus, the patient's experience has been transformed from a boring or frustrating experience to a simplified and educational experience, with the opportunity for entertainment.

With respect to the service provider, the professional can review the patient's current information before the patient arrives and select, from the database 44, one or more informative documents and/or tests to be provided to patient via the device 10. Then, prior to or even while actually seeing the patient, the physician can check to see if the patient accessed the materials or took the test, whether the patient completed the test, how the patient scored on the test, changes in the patient's medical history or symptoms, questions or comments that the patient may have, medication refill requests, etc. This allows the physician to make informed decisions regarding further questions to ask the patient, tests to be suggested, treatment options that may be appropriate for that patient, etc.

When the patient is first provided the device 10, there are several options available. As one option, the data port 12 communicates via a wireless link with the system 30 to obtain the patient information, documents, forms, etc., and also to send information provided by the patient back to the server 30. In this embodiment, for security purposes, it is preferred that the patient log in. The patient may log in by using a one-time code provided by the receptionist, a user ID and a password, a social security number or other identifying numbers and/or letters, etc., or any desired combination thereof. Also, preferably, when the patient's session with the device 10 has been completed, any patient information in the memory 14 is securely erased. A time-out security feature may also be provided so that, after a certain amount of time, or at a certain time, or upon the occurrence of a certain event (e.g., the device 10 is inserted into a docking station, or loses communication with the server 30, etc.), then the device 10 may automatically lock, the display may be a default screen, any patient information in the device 10 or the memory card is automatically erased, etc. As additional security, the data and/or transmissions may be encrypted.

As another option, the receptionist may insert a memory card into the data port 12 or hand the memory card to the patient to insert into any available device 10. The memory card may have the patient information, documents, forms, videos, etc. thereon. Security techniques, such as described above, may also be used. Once the patient has completed the forms, documents, and/or tests, then the patient may return the device 10 or the memory card to the receptionist. The receptionist will then insert the memory card into a data port 32 of the system 30 and the information that the patient provided, test results, etc., will be uploaded to the database 44.

As another option, the receptionist may insert a memory card into the data port 12 or hand the memory card to the patient to insert into any available device 10. The memory card may be encoded to identify that patient in order for the device 10 to obtain that information from the system 30 via a wireless link. Security techniques, such as described above, may also be used.

In one implementation, immediately upon the arrival of the patient, the patient is provided with a device 10. The patient then follows the on-screen prompts and queries to check-in and, if and to the extent allowed by the service provider, manages his profile, electronically completes required paperwork, and signs any necessary consent forms. This provides for easy and quick check-in by and for the patient. Within seconds the patient's arrival is confirmed. In one use, a professional, such as a nurse, notifies the patient of his room availability and location. In another use, the device 10 notifies the patient and provides directions to the room once it becomes available.

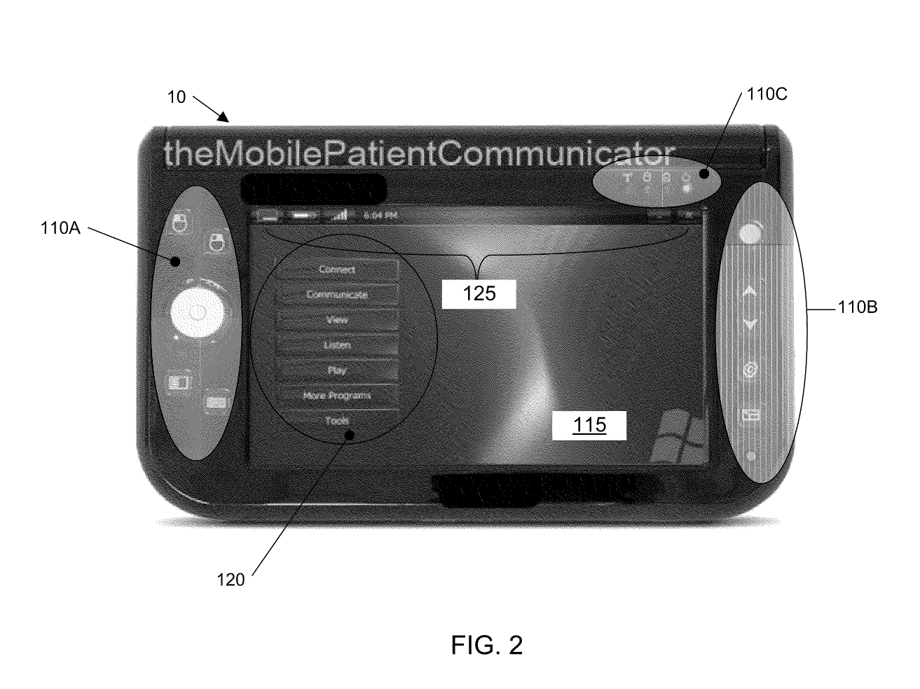

FIG. 2 is an exemplary embodiment of a portable patient communication device. The device 10 preferably, but not necessarily, has button sets 110A, 110B, 110C, and a touch-sensitive screen 115 which displays appropriate option buttons 120 and an information bar 125.

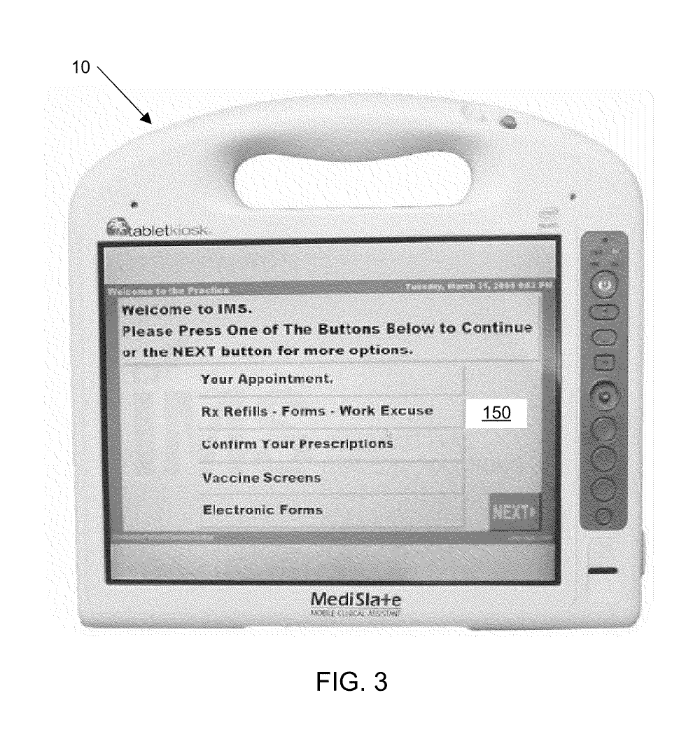

FIG. 3 is an illustration of an exemplary screen 150 as implemented on another embodiment of the device 10. This display screen may be the initial screen, or it may be a screen that is displayed once the patient completes or updates his medical history.

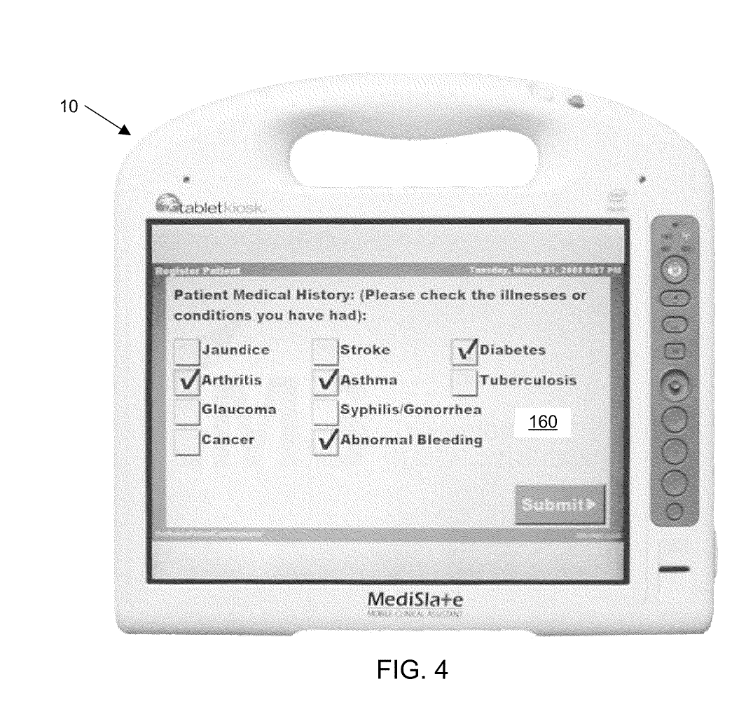

FIG. 4 is an illustration of part of an exemplary patient medical history intake form or questionnaire display 160. This display lists various illnesses, medical conditions, and/or symptoms and allows the patient to “check” the box by touching the touch-sensitive screen. Once this screen has been completed the patient can press “submit” and the device will then present the next screen, which may be more illnesses, medical conditions, and/or symptoms, may ask for other information, such as any change in address or medical insurance carrier, may allow the patient to input any information that was not asked but that the patient wants the doctor to know, input questions or concerns that the patient may have, request refills or a change in a prescription, etc. This provides for management of the patient's profile by the patient (if, and to the extent, permitted), updating of forms and information, immunization screening and consent, access to a personal web page of the patient, if desired, and education of the patient.

For returning patients, historic information for each form is preferably displayed for review and may be editable to the extent permitted by the service provider; some patients may have substantial editing permissions, other patients may have only read-only access, or even be limited to access to certain files. Preferably, any such changes are not immediately made permanent, but are made as a temporary change until reviewed and approved by a professional. Such temporary changes may be indicated by redlining or any other desired technique. Potential errors and or inconsistencies are preferably marked by highlighting or other desired technique for review and approval, correction, or rejection by a professional. Preferably, all patient inputs are time stamped, all staff modifications and approvals are time stamped, and either a secure electronic signature or a signature box is used for forms requiring the patient's signature, such as, but not limited to, sign-in forms, medical history forms, patient confirmation and/or consent forms, visitor authorization forms, etc. Also, in one implementation, forms (whether blank or completed) may be printed or emailed with the approval of the appropriate supervisory professional.

In addition to written documents and forms, audio instructions can be provided via the device 10 for those who cannot read the information being displayed.

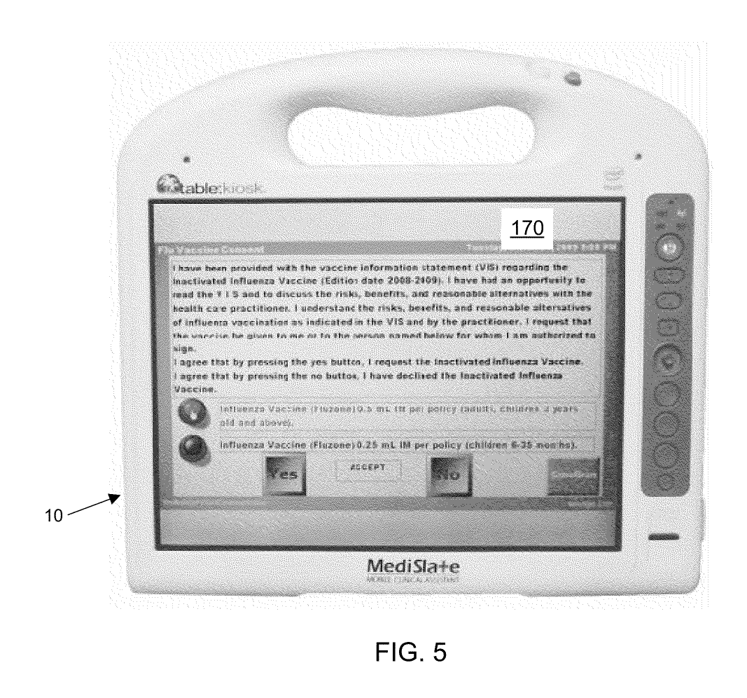

FIG. 5 is an illustration of an exemplary consent display 170. This display provides an exemplary consent agreement, a description of what the patient is consenting to, and “yes” and “no” buttons to accept or reject, respectively, the consent agreement. Other screens (not shown) may also provide information on side effects, cautions against use with other medications, persons who should not use that medication or treatment, etc. As mentioned, certain forms require the patient's signature. These forms, such as, but not limited to, check-in documents and medical history updates are preferably provided to each patient or his/her guardian at the appropriate time during the visit to the medical facility. These documents are preferably completed, reviewed and validated electronically. Educational compliance and consent, medication and procedural consent, confirmation and adherence forms are also preferably provided, reviewed and signed electronically. Psychological questionnaires or assessment forms, survey questionnaires and educational assessments are also implemented electronically. Preferably, professionals of the service provider, such as staff members, are able to dynamically prioritize the sequence in which the forms are presented to any patient at any time.

Preferably, an employee of the service provider will review and approve all forms completed or modified by or for each patient before they are permanently recorded in the patient's medical record. Service provider staff can preferably modify questions and answers for any questionnaire or survey for each patient.

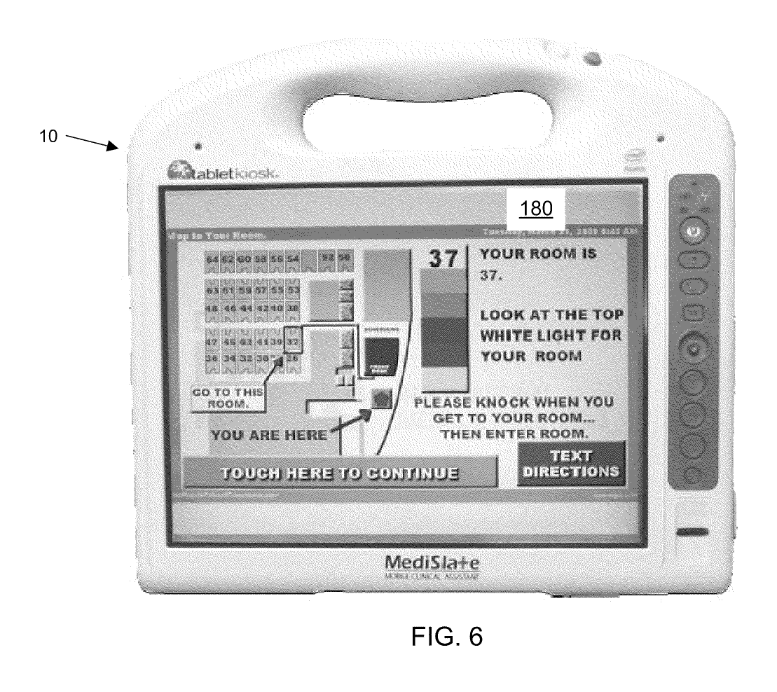

FIG. 6 is an illustration of an exemplary display 180 guiding the patient to a desired location. This provides a “self-rooming” capability whereby an employee does not have to lead the patient from one room to another, such as from the waiting room to the examination room, or from the examination room to the X-ray room. This display shows the patient where he is, where he is going, things to help the patient know he is going in the correct direction, the room number or other location identifier, and instructions as to what to do once the patient arrives at the destination. A “text direction” option is also shown. Once the patient reaches the location then the patient can press the “Touch Here To Continue” button for the next instructions, such as: “please disrobe and put on the hospital gown provided to you”, “please have a seat, the doctor will be here shortly”, “please lie down and relax so that a resting blood pressure and heart rate can be obtained”, “please remove all metal articles”, etc. The information presented on the screen of the device may change depending upon where the patient is. For example, if the patient turns the wrong way, the display may change to provide a new set of directions. The location of the patient may be determined, for example, by sensors (not shown) located throughout the facility which detect transmissions from the device 10, whether or not a memory card is used, by a Global Positioning System (GPS) sensor in the device 10 which then transmits its GPS coordinates to the system 30, etc. The patient's location can also be tracked and displayed on the professional’ communication device 200 or at a terminal of the system 30. The directions may be provided audibly in addition to, or instead of, being presented on the display screen of the device 10. Also, if desired, another screen could provide updates to the patient on the doctor's progress and expected time of arrival.

In one implementation, when a patient's appointment time arrives, the patient is notified by the device 10, with both text and audio, of the destination room number and exact location, and is then prompted to proceed there via step-by-step directions. The patient then simply follows a digital map and “self-rooms” in their assigned exam room, thereby eliminating the need for an employee to escort the patient. Once roomed, the patient simply touches the screen to notify the nurse. The nurse may then send a message to the patient to view specific educational content and to update the patient on the doctor's status.

Each patient's itinerary may be dynamically managed electronically by the appropriate staff. The patient's location and activities may be monitored electronically at all times and viewable by the staff members. The patient's itinerary may be updated dynamically and wirelessly at any time by the appropriate staff member.

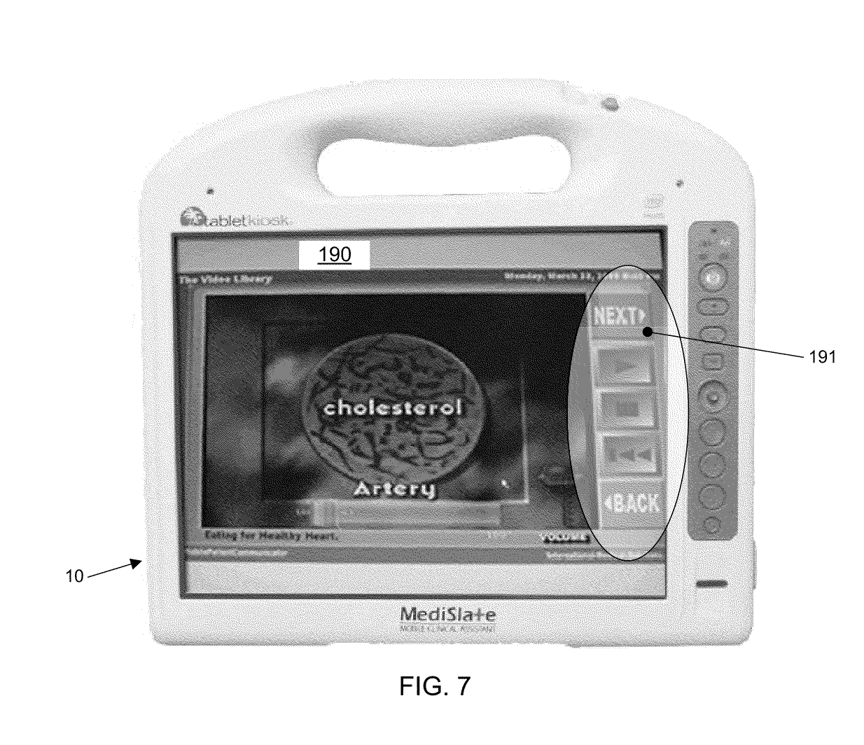

FIG. 7 is an illustration of an exemplary patient education video display 190. This display also has screen buttons 191 which allow the patient to control the video playback. Preferably, in order to avoid disturbing other persons or patients, the patient uses a headphone (not shown) to hear any audio associated with the video. Preferably, access to videos is wireless, but could be via information on a memory card. Some examples of videos which may be provided are: chronic disease management, testing before and after the video to determine the initial and later patient knowledge on the disease or condition, tutorials for incorrect answers, and a patient satisfaction survey.

Thus, during the otherwise non-utilized wait time, a patient can view informative videos about his particular acute illness, chronic condition and/or medical procedures, subject matter specific to the patient's stage of care, treatment regimen, rehabilitation, care plan, and disease management, and can take a test to determine what information, and how much information, they have retained. Preferably, the video start and stop times and the times when a question was answered are recorded for future evaluation of the benefit of that particular video to that patient and patients in general.

For example, high-risk cardiac patients must be watched closely, require detailed medication counseling, need thorough tutoring and must be given specific instruction on activities to avoid. In such cases, patient and patient family education is not only required, but can be potentially life saving. For example, warfarin therapy requires nurses to conduct educational sessions lasting from 30-45 minutes to cover medication dosing and complications. With the present invention, a nurse can play an informative video on proper warfarin use, risks and benefits for the patient to view in a private, quiet area. The patient can be automatically tested at specified times during the video and during the appointment to reinforce learning and to test for recall and retention.

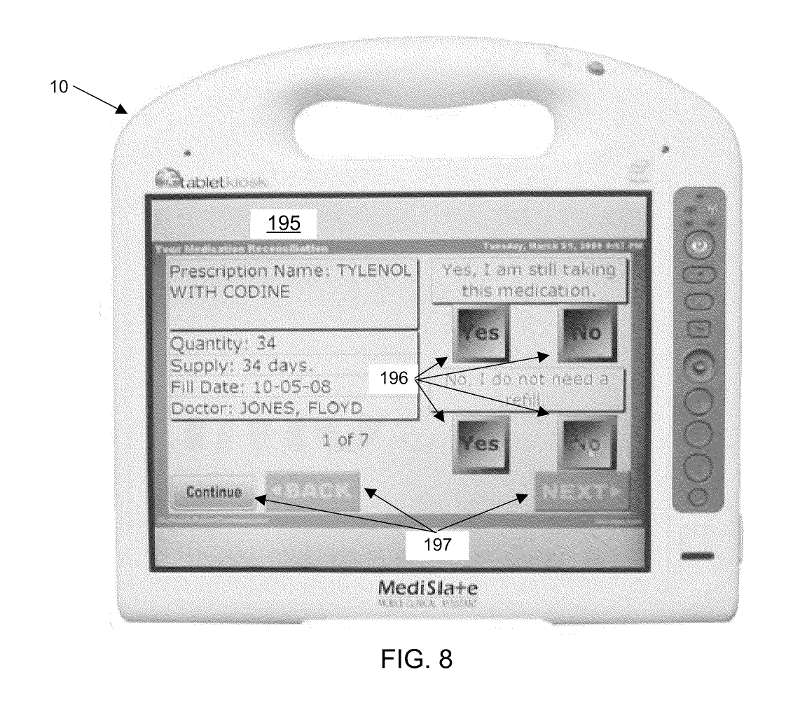

FIG. 8 is an illustration of an exemplary medication reconciliation status display 195. This display shows some of the medications that were prescribed for the patient and allows the patient to indicate, such as by screen buttons 196, whether the patient is currently taking the medication or whether the patient needs a refill. This display also has screen buttons 197 which allow the patient to move to display screen for the next (or previous) medication. The display may also provide screens (not shown) which allow the patient to ask questions about the medication, advise the doctor of the effectiveness of the medication, problems with the medication, side effects of the medication, list other medications, vitamins, supplements, etc., that the patient is taking, etc.

For example, the patient may directly enter the information about the medication, vitamin, etc., and that information is stored in the patient's record. The patient can also indicate any concerns, questions, etc., about the item.

The patient may also bring the prescription or non-prescription medication bottle or container into the service provider's office and the information on the bottle or container can be scanned and saved into the patient's record. The patient can also indicate any concerns, questions, etc., about the item.

Further, the database 44 preferably has a listing of all known medications, and preferably all known vitamins, herbs, supplements, etc., and, still using the device 10, the patient can search the database by the name or part of the name of the medication, vitamin, herb, supplement, etc., or the patient can search by the topic or area associated with the medication, etc. For example, the patient can search for “warfarin”, “statin”, “allergy”, “high blood pressure”, “blood thinner”, “glaucoma”, etc. When the patient locates the item, the patient can simply “click” on the item, and the information will then be imported into the patient's record. The patient can also indicate any concerns, questions, etc., about the item.

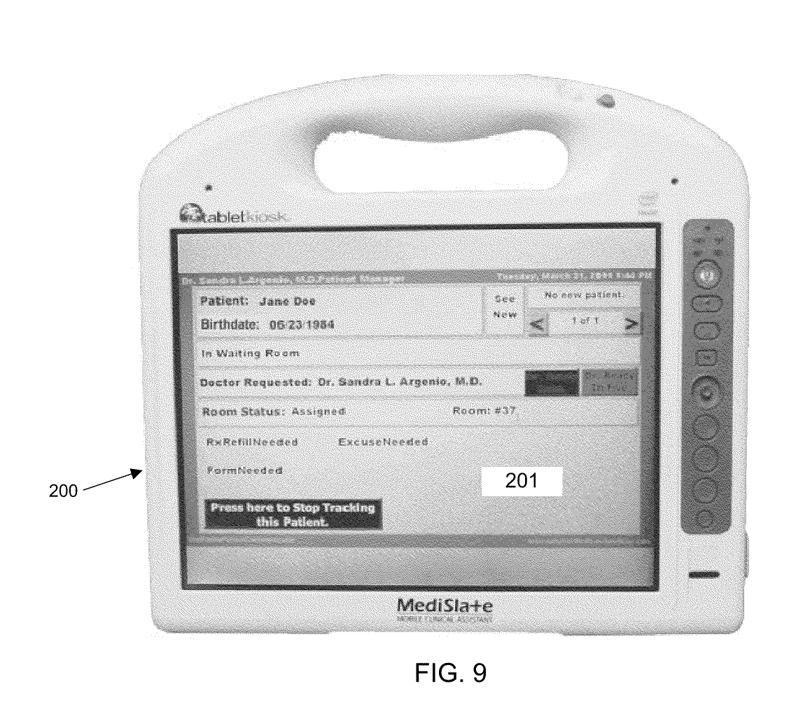

FIG. 9 is an exemplary embodiment of a professional communication device 200. This device is similar in construction and operation to that of a patient communication device 10, but has “administrator” privileges, and can therefore access and control features and functions which a patient cannot. For example, the display 201 may provide basic patient identifying information, the doctor requested or assigned, where the patient is currently located, and other information. The professional can also use the device 200 to review and select articles and videos for each patient, specify whether the patient has Internet access, specify whether the patient can access the medical library, communicate with the patient through the patient's device 10, etc.

Thus, from the above, it will be seen that the doctor or other professional can, using the interface device 38, view the patient's information as well as other documents on the database 44, select forms to be completed by the patient, patient information to be reviewed and updated by the patient, articles for the patient to review, and tests for the patient to take. This information may be stored on a memory device which will later be inserted into the patient communication device. Then, when the patient arrives, the patient is presented with a patient communication device 10. The device 10 is activated, such as by the patient entering an appropriate password or by the insertion of the memory device into a data port 12. Once activated, the device 10 obtains the information to be presented to the patient, either from the memory device or from a wireless link to the service provider operating system 30. The patient then views the screens and, using either icons or buttons on the screen, or physical buttons on the device, updates the patient's information, presents questions for the professional, takes a test of the patient's knowledge, reads information selected by the professional, browses on the Internet, etc. The information provided by the patient, test results, etc., may be stored on the memory device and/or may be transmitted via the wireless link to the system 30 for storage. In either case, the new information and test results are available for the professional to review. The device 10 may also be used to provide directions to the patient so that the patient can go to the designated room, or go from one designated room to another designated room, without assistance. The device 10 also allows for tracking of the patient in the event that the patient is not in the designated room at the appointed time. In addition, the device 10 allows the patient to request refills, an excuse from work, indicate problems with medications, indicate other medications that the patient is taking, etc. When the patient's visit is completed, or when the device 10 is returned, the memory 14 in the device 10 is erased to remove the patient's information. Similarly, after any new information has been uploaded to the database 44, then any memory card provided to the patient is erased.

Other screen displays and information are possible such as, for example, an Internet browser screen. Also, the screen displays shown may be modified as needed for a particular medical or other environment.

It should be noted that it is not necessary to implement all of these features or benefits, or all of the above screen displays. Rather, the reader may choose to implement selected ones of the features, benefits and screen displays, and not implement other features, benefits and screen displays. Various features and benefits of the present invention will become apparent upon reading the following description of the preferred embodiment, when taken in conjunction with the drawings and the claims.

Conditional language, such as, among others, “can”, “could”, “might”, or “may”, unless specifically stated otherwise, or otherwise understood within the context as used, is generally intended to convey that certain embodiments optionally could include, while some other embodiments do not include, certain features, elements and/or steps. Thus, such conditional language indicates, in general, that those features, elements and/or step are not required for every implementation or embodiment.

1. A patient communication device, comprising:
a wireless data port to receive data related to at least one of information concerning a person, information for a person, or operating instructions;
an interface device to at least one of display information to a person or to receive information from a person;
a memory to contain operating instructions; and
a processor, functionally connected to the wireless data port, to the interface device, and to the memory, to retrieve and execute an operating instruction, and at least cause a portion of the information received by the data port to be displayed on the interface device or cause at least a portion of the information received by the interface device from the person to be stored.

2. The patient communication device of claim 1 wherein the wireless data port receives data related to a person, and the processor causes at least a portion of the information to be displayed on the interface device.

3. The patient communication device of claim 1 wherein the wireless data port receives data related to the personal information of the person, and the processor causes at least a portion of the personal information of the person to be displayed on the interface device.

4. The patient communication device of claim 1 wherein the wireless data port receives data relating to medical information, and the processor causes at least a portion of the medical information to be displayed on the interface device.

5. The patient communication device of claim 1 wherein the interface device receives information from a person and the processor causes at least a portion of the information to be stored in the memory or transmitted via the wireless data port.

6. The patient communication device of claim 1 wherein the wireless data port receives directional information data to be displayed for the person, and the processor causes at least a portion of the directional information for the person to be displayed on the interface device to assist the person in going to a designated location.

7. The patient communication device of claim 1 wherein the wireless data port receives testing information for a person, and the processor causes at least a portion of the testing information to be displayed on the interface device, and wherein the interface device receives test answers from the person and the processor causes at least a portion of the test answers to be stored in the memory or transmitted via the wireless data port.

8. A method for exchanging information, comprising:
displaying a plurality of documents at a first device;
receiving at the first device a selection of at least one document to be exchanged;
sending the document from the first device to a second device via a wireless connection;
receiving the document at the second device;
displaying the document at the second device;
receiving information at the second device in response to the document being displayed at the second device;
sending the information from the second device to the first device via a wireless connection; and
storing, in the first device, the information received from the second device.

9. The method of claim 8 wherein sending via a wireless connection comprises sending via a wireless link.

10. The method of claim 8 wherein sending the document via a wireless connection comprises the first device storing the document on a memory card, and the second device reading the document from the memory card.

11. The method of claim 8 wherein sending the information via a wireless connection comprises the second device storing the information on a memory card, and the first device reading the information from the memory card.

12. The method of claim 8 wherein sending the document comprises sending information and a test on the information.

13. The method of claim 12 and further comprising displaying the test on the second device, receiving answers to the test, and sending the answers as information to the first device.
